(19) United States
(12) Patent Application Publication
(10) Pub. No.: US 2002/0147543 A1
(43) Pub. Date: Oct. 10, 2002

(54) Apparatus and method for seeking a motor vehicle parking space

(76) Inventor: Arnold Gieseke, Giesen, DE (US)

Correspondence Address: Patrick J. O'Shea, Esq., Samuel, Gauthier & Stevens LLP, Suite 3300, 225 Franklin Street, Boston, MA, 02110, US

(21) Appl. No.: 10/096,326

(22) Filed: Mar. 11, 2002

(30) Foreign Application Priority Data
Mar. 10, 2001 (DE) 101 11 588. 1

(51) Int. Cl. G01C 21/26

(52) U.S. Cl. 701/200; 701/1

(57) ABSTRACT

To facilitate seeking and driving to a parking space in a vehicle, the vehicle is equipped with a navigation system which, when a target parking space has been entered, establishes a radio connection to a server, calls up parking space occupancy data stored in the server, and transmits them visually and/or audibly to the driver. Once a target parking space has been entered, the navigation system calls up the data needed for driving to the target parking space from the server and guides the driver to the target parking space.

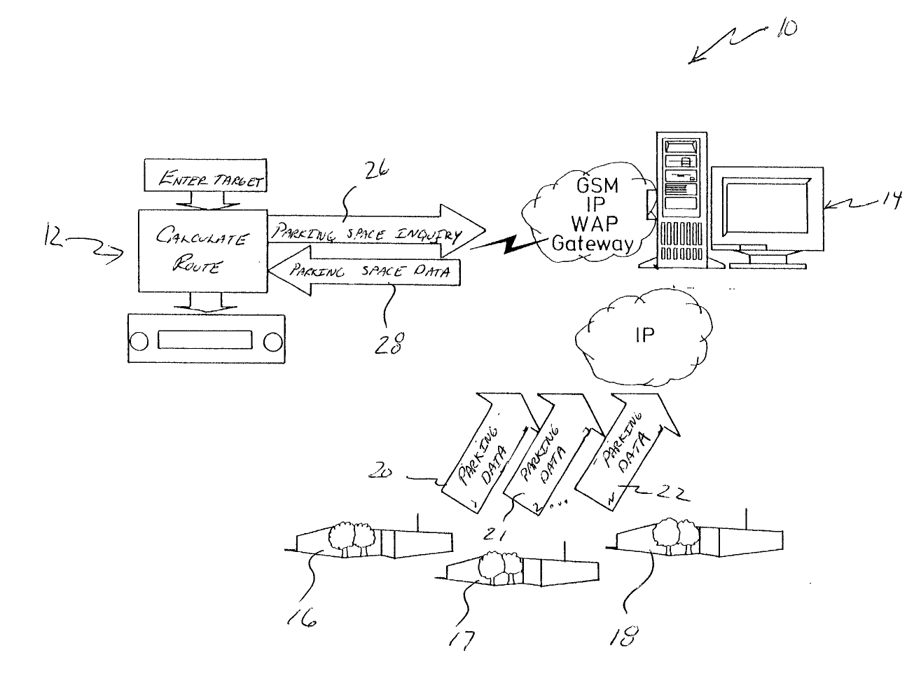

### BACKGROUND OF THE INVENTION

The present invention relates to the field of motor vehicle navigation systems, and in particular to a system and method for providing parking space data to a motor vehicle equipped with a navigation system.

ADAC Motorwelt 9, 2000, page 68 describes a parking guidance system set up in the city of Freiburg, Germany. Numerous displays erected in the city inform drivers visually of the currently available parking spaces in parking lots and parking garages. In addition, information can be found on the Internet on the number of free parking spaces, local public transit schedules and routes, bicycle paths, and the layout, fees, opening times, and women's parking spaces in garages. There are plans to make some of this information available via a cellular telephone suitable for the Wireless Application Protocol (WAP).

Although this known parking guidance system makes it considerably easier for the driver to seek and drive to a parking space, it is still in need of improvement, and specially to provide the parking information to an operator in a motor vehicle.

Therefore, there is a need for a motor vehicle parking guidance system that provides information to a motor vehicle operator to assist the operator in finding a parking space.

### SUMMARY OF THE INVENTION

Briefly, according to an aspect of the invention, a motor vehicle parking guidance system includes a server in which data indicative of the current occupancy of the parking spaces in an area, for example a city, are stored. Navigation system equipped motor vehicles establish a radio connection to this server, and call up data from the server on parking space availability, and provide the data visually and/or audibly to the motor vehicle operator. The driver can choose a target parking location from the available parking spaces presented by the navigation system, and the data needed to guide the vehicle to the target parking space is transmitted from the server to the navigation system.

Advantageously, seeking and driving to an available parking space is made considerably easier for the driver because he has only to enter the target location in his navigation system and choose a target parking space from the list of parking spaces offered. The navigation system then guides the driver to the target parking space he has chosen.

These and other objects, features and advantages of the present invention will become more apparent in light of the following detailed description of preferred embodiments thereof, as illustrated in the accompanying drawings.

### BRIEF DESCRIPTION OF THE DRAWING

The FIGURE is a block diagram illustration of a motor vehicle parking guidance system.

### DETAILED DESCRIPTION OF THE INVENTION

The FIGURE is a block diagram illustration of a motor vehicle parking guidance system 10. The system includes a motor vehicle navigation system 12 that communicates via a wireless connection to a server 14. The server 14 includes data indicative of parking space availability in an area (e.g., a city) and geographic location of a plurality of parking locations, such as for example, parking garages 16-18. Of course, more than three parking garages or parking facilities can be associated with the server. The server 14 regularly receives data 20-22 (e.g., parking space availability data) from monitoring systems in the parking garages 16-18, respectively, and stores the data 20-22 for call up by the motor vehicle navigation system 12. Data exchange between the navigation system 12 and the server 14 can take place for example by the Global Standard for Mobile Communications (GSM), and according to the wireless access protocol (WAP).

If a driver wishes to obtain parking space availability data at a target location A, the driver enters the target location A into the navigation system 12. The navigation system 12 then transmits a parking space inquiry 26 to the server 14 over the wireless channel. In response, the server 14 reads the parking space inquiry, accesses its database of parking data, and transmits parking space data 28 associated with the target location A to the navigation system 12 over the wireless channel.

The navigation system 12 provides the parking space data to the driver, visually and/or audibly. The parking space data may include how many parking spaces are currently available at the individual parking lots and individual parking garages, so that the driver can select the parking lot or garage most convenient to him and enter it in the navigation system. Once the target parking space has been entered in the navigation system, the navigation system calls up the data needed for driving to the target parking space (e.g., the street and number of the parking lot or parking garage) from the server 14 and guides the driver to the target parking space.

Significantly, seeking and driving to a parking space are made easier for the driver because he has only to enter the target location in his navigation system and choose a target parking space from the list of parking spaces offered. The navigation system then guides the driver to the target parking space he has chosen.

For example, the driver is shown a list of available parking spaces on a display or a map giving the number of available parking spaces and their correct locations. Instead of or as well as this, the numbers and locations of the available parking spaces are communicated to the driver by an audible announcement.

In one embodiment, the data are preferably transmitted between the navigation system 12 and the server 14 by the Wireless Application Protocol (WAP). In the server, the data may be stored in markup language, such as for example in the Extensible Markup Language (XML). The navigation system informs the server of the Wireless Markup Language (WMIL) in which the server should send the data to the navigation system.

Once the target parking space has been received from the navigation system 12, the server 14 updates the number of unoccupied parking spaces stored in its database.

From the navigation system 12, information on current parking space occupancy, parking such as garages, and the addresses of individual parking lots, parking garages, and parking facilities can be called up from the server. From these data, once the target parking space has been entered, the navigation system calculates the route to the target parking space and guides the driver there.

The navigation system is provided with a visual and/or audible system to communicate to the driver the data called up from the server on current parking space occupancy, for example on a display and/or by an audible announcement. In addition, the navigation system is provided with an input device (e.g., a keypad such as a touch screen keypad) by which the driver can enter the target location and target parking space. The navigation system may also already know the target location, since it is typically the specified destination for the trip (if so specified). Also, the input device can be expanded so that the driver can enter the method of paying the parking fee—cash, credit card, or on the telephone bill—into the navigation system.

The parking guidance system may also include a reader device (e.g., a video camera), at the parking lots, for example at the entrance and exit of a parking facility or a parking garage to read the vehicle identification number when the vehicle arrives and leaves. This provides the arrival and departure times from which the parking duration and parking fees can be automatically calculated. Preferably, the navigation system 12 is designed such that the driver can enter his vehicle identification number, which can be transmitted from the navigation system to the server.

Although the present invention has been shown and described with respect to several preferred embodiments thereof, various changes, omissions and additions to the form and detail thereof, may be made therein, without departing from the spirit and scope of the invention.

What is claimed is:

1. A motor vehicle navigation system that communicates with a wireless station to obtain parking space availability data, said motor vehicle navigation system comprising:
means for transmitting a parking space inquiry signal over a wireless communication channel;
means for receiving data indicative of candidate parking locations that the motor vehicle can park in response to said parking space inquiry signal; and
means for displaying said data indicative of candidate parking locations.

2. The motor vehicle navigation system of claim 1, wherein said means for receiving includes a radio receiver.

3. The motor vehicle navigation system of claim 2, wherein said means for displaying includes a touch screen display that allows a user to enter data indicative of a target parking location.

4. The motor vehicle navigation system of claim 1, further comprising:
means for selecting a parking location from said data indicative of candidate parking locations, and for transmitting data indicative of a selected parking location over the wireless communication channel; and
means for receiving navigation data indicative of driving directions to the selected parking location, and for presenting said received navigation data to a motor vehicle operator.

5. The motor vehicle navigation system of claim 4, wherein said means for receiving and for presenting comprises:
a radio receiver that receives said navigation data indicative of driving directions to the selected parking location;
a processing unit that processes the received navigation data indicative of driving directions to the selected parking location, and provides display data indicative of driving directions to the parking location; and
a display that receives and displays said display data.

6. The motor vehicle navigation system of claim 5, wherein said radio receiver is configured and arranged to receive data transmitted according to the by the Wireless Application Protocol (WAP).

7. The motor vehicle navigation system of claim 5, wherein radio receiver receives said navigation data that data indicative of the address of the selected parking space.

8. The motor vehicle navigation system of claim 1, wherein said means for transmitting said parking space inquiry signal informs a server of the Wireless Markup Language (WML) in which said data indicative of candidate parking spaces are to be transmitted said navigation system.

9. The motor vehicle navigation system of claim 1, wherein said means for receiving receives data in the WNL format.

10. A method of communicating with a wireless station to obtain motor vehicle parking space availability data, said method comprising:
transmitting a parking space inquiry signal over a wireless communication channel;
receiving wireless data indicative of candidate parking locations that the motor vehicle can park in response to said parking space inquiry signal; and
displaying said wireless data indicative of candidate parking locations.

11. The method of claim 10, further comprising:
selecting a parking location from said wireless data indicative of candidate parking locations;
transmitting data indicative of a selected parking location over the wireless communication channel;
receiving navigation data indicative of driving directions to the selected parking location; and
presenting said received navigation data to a motor vehicle operator.

12. A motor vehicle navigation system that communicates with a wireless station to obtain parking space availability data, said motor vehicle navigation system comprising:
a radio transmitter for transmitting a parking space inquiry signal;
a radio receiver that receives data indicative of candidate parking locations that the motor vehicle can park in response to said parking space inquiry signal; and
a display that presents display data indicative of the candidate parking locations.
